(19) United States
(12) Patent Application Publication
(10) Pub. No.: US 2026/0314531 A1
(43) Pub. Date: Oct. 15, 2026

(54) AGRICULTURAL YIELD MONITORING AND ESTIMATION DEVICES, SYSTEMS, AND METHODS

(71) Applicant: Ag Leader Technology, Ames, IA (US)

(72) Inventors: Tony Woodcock, Ames, IA (US); Scott Eichhorn, Ames, IA (US); Roger Zielke, Huxley, IA (US)

(21) Appl. No.: 19/545,989

(22) Filed: Feb. 20, 2026

Related U.S. Application Data
(60) Provisional application No. 63/760,907, filed on Feb. 20, 2025.

(51) Int. Cl. A01D 41/127

(52) U.S. Cl. CPC A01D 41/1271

(57) ABSTRACT

A row-by-row yield monitoring system for agricultural harvesters. The system includes a camera configured to capture images of crop entering individual row units of a harvester, a plant detection sensor configured to detect individual crop plants, and a mass flow yield sensor configured to measure total harvested crop mass flow. A processor receives data from the camera, plant detection sensor, and mass flow yield sensor to estimate yield for each individual row unit. The processor detects and measures crop fruit size from the captured images, multiplies counted plants by measured crop fruit size to determine a plant-fruit value for each row, and calculates each row's proportion of the total mass flow based on the plant-fruit values. Time delay buffers align data from the various sensors to correspond to the same field location.

### CROSS-REFERENCE TO RELATED APPLICATION(S)

This application claims the benefit under 35 U.S.C. § 119 (e) to U.S. Provisional Application 63/760,907, filed Feb. 20, 2025, and entitled Agricultural Yield Monitoring and Estimation Devices, Systems, and Methods, which is hereby incorporated herein by reference in its entirety for all purposes.

### TECHNICAL FIELD

The disclosure relates to agricultural harvesting and yield monitoring.

### BACKGROUND

When a combine is equipped with a yield monitor, the combine operator (i.e. farmer) is able to receive data on harvest yields while in the field. The data presented to the farmer can be viewed geospatially and plotted across a field. This allows the farmer to see what areas have the highest and lowest yields and help the farmer assess what can be done to improve low performing areas.

Because the yield monitor is located within a combine harvester at a point after all the crop within the harvester head has been collected and combined to be deposited in the storage tank, the data collected from the yield monitor is only accurate for an area the size of the harvesting head and a linear distance. This limitation in precision of the yield data prevents the farmer from being aware of yield disparities that may exist between neighboring rows of corn and determining if additional measures need to be taken to prevent losses at harvest. These measures may include the adjustment of crop care additives such as, but not limited to, herbicides and fertilizer or may reflect mechanical issues present when planting such as a malfunctioning seed trench closing wheel.

For row crop harvesting, without the ability to know precise row yields, farmers may not be able to assess crop performance issues until a significant area is affected and can be represented by current yield monitors. This causes a loss of income due to reduced harvest yields and an increased cost in crop care. If the farmer can receive data that precisely determines which row or plants within a field are in need of improvements before a substantial area is affected, then the farmer can prevent a loss of income and increase in costs.

### BRIEF SUMMARY

A system of one or more computers or computing devices can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

In Example 1, a row-by-row yield monitoring system for a harvester having a plurality of row units, the system comprising a camera configured to capture images of crop entering at least one row unit of the harvester, a plant detection sensor configured to detect individual crop plants entering the at least one row unit, a mass flow yield sensor configured to measure a total mass flow of harvested crop, and a processor in communication with the camera, the plant detection sensor, and the mass flow yield sensor. The processor configured to receive image data from the camera, detect and measure a size of crop fruit in the image data, receive plant count data from the plant detection sensor, receive mass flow data from the mass flow yield sensor, and estimate a yield for each individual row unit based on the crop fruit size, the plant count data, and the mass flow data.

Example 2 relates to the system of any of Examples 1 and 3-12, wherein the camera is mounted on a snoot of the harvester and positioned such that a field of view of the camera captures crop stalks and crop fruit entering the at least one row unit.

Example 3 relates to the system of any of Examples 1-2 and 4-12, wherein the camera is positioned such that a field of view of the camera covers a deck plate area of the at least one row unit.

Example 4 relates to the system of any of Examples 1-3 and 5-12, wherein the camera is positioned such that a field of view of the camera covers an ear intake area of the at least one row unit.

Example 5 relates to the system of any of Examples 1~4 and 6-12, wherein the camera is positioned such that a field of view of the camera covers a cross-auger ear transport area of the harvester.

Example 6 relates to the system of any of Examples 1-5 and 7-12, further comprising a depth sensor configured to determine a distance from the camera to crop fruit.

Example 7 relates to the system of any of Examples 1-6 and 8-12, wherein the camera is a stereo camera configured to measure depth.

Example 8 relates to the system of any of Examples 1-7 and 9-12, further comprising a row alignment sensor configured to measure a distance from the camera to a planted crop row.

Example 9 relates to the system of any of Examples 1-8 and 10-12, wherein the processor is further configured to multiply a counted plant number by a measured crop fruit size for each row unit to determine a plant-fruit value for each of the plurality of row units, sum the plant-fruit values for each of the plurality of row units to determine a plant-fruit total, and calculate a mass flow proportion for each of the plurality of row units by dividing the plant-fruit value of each of the plurality of row units by the plant-fruit total.

Example 10 relates to the system of any of Examples 1-9 and 11-12, wherein the processor is further configured to align data from the camera, the plant detection sensor, and the mass flow yield sensor in time using a time delay buffer.

Example 11 relates to the system of any of Examples 1-10 and 12, wherein the processor is further configured to estimate time delays using a state estimation algorithm.

Example 12 relates to the system of any of Examples 1-11, wherein the processor is further configured to calculate a speed and sample region length for each individual row unit when the harvester is moving along a curved path.

In Example 13, a method of estimating row-by-row yield during harvesting, the method comprising capturing, via a camera, images of crop entering a plurality of row units of a harvester; detecting and measuring, via a processor, a size of crop fruit in the captured images; detecting, via a plant detection sensor, individual crop plants entering each row unit; measuring, via a mass flow yield sensor, a total mass flow of harvested crop; and estimating, via the processor, a yield for each individual row unit based on the crop fruit size, a plant count from the plant detection sensor, and the total mass flow.

Example 14 relates to the method of any of Examples 13 and 15-18, further comprising multiplying a counted plant number by a measured crop fruit size for each row unit to determine a plant-fruit value, summing the plant-fruit values for each of the plurality of row units to determine a plant-fruit total, calculating a mass flow proportion for each of the plurality of row units by dividing the plant-fruit value of each of the plurality of row units by the plant-fruit total, and calculating the yield for each of the plurality of row units based on the mass flow proportion.

Example 15 relates to the method of any of Examples 13-14 and 16-18, further comprising determining a distance from the camera to the crop fruit using at least one of: a depth sensor, a stereo camera, a row alignment sensor, or GPS position data combined with previously collected planted row position data.

Example 16 relates to the method of any of Examples 13-15 and 17-18, further comprising aligning data from the camera, the plant detection sensor, and the mass flow yield sensor in time by holding data from each sensor in a time delay buffer.

Example 17 relates to the method of any of Examples 13-16 and 18, further comprising estimating time delays using a state estimation algorithm.

Example 18 relates to the method of any of Examples 13-17, further comprising estimating, for crop plants where crop fruit is not detectable in the captured images due to obscuration, a size of the crop fruit based on sizes of crop fruit that were detected and measured.

In Example 19, a non-transitory computer-readable medium storing instructions that, when executed by a processor, cause the processor to receive image data from a camera capturing images of crop entering a plurality of row units of a harvester, detect and measure a size of crop fruit in the image data, receive plant count data from a plant detection sensor detecting individual crop plants entering each row unit, receive mass flow data from a mass flow yield sensor measuring a total mass flow of harvested crop, and estimate a yield for each individual row unit based on the crop fruit size, the plant count data, and the mass flow data.

Example 20 relates to the non-transitory computer-readable medium of Example 19, the processor further configured to align data from the camera, the plant detection sensor, and the mass flow yield sensor in time by holding data from each sensor in a time delay buffer.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a front view of a harvester, according to one implementation.

FIG. 2 is a schematic overview of the system, according to one implementation.

FIG. 3 is a top view of a harvester row unit, according to one implementation.

FIG. 4 is a side view of a harvester row unit, according to one implementation.

FIG. 5 is a top view of a harvester row unit, according to one implementation.

FIG. 6 is a top view of a harvester row unit, according to one implementation.

FIG. 7 is a schematic view of the system, according to one implementation.

FIG. 8 is a top view of a harvester row unit, according to one implementation.

FIG. 9A is a graphical representation of a camera view of an ear, according to one implementation.

FIG. 9B is a graphical representation of a camera view of an ear, according to one implementation.

### DETAILED DESCRIPTION

Disclosed herein is a system that can collect data for individual corn rows as they are being harvested and calculate an estimated yield for that row. The system may also be able to differentiate weight that is from corn plant material, i.e. stalks and leaves, and corn kernels to determine an accurate yield measurement. The system may also be able to account for the corn mixing within the cross auger and impact of corn within the auger trough. The system may then present the yield data and location to the operator so that the operator can see the yields of the individual rows. This allows farmers to know the individual yield of rows across a linear distance and make finer adjustments to their farming practices as needed. Knowing the row-by-row yield enables the farmer to take action that reduces cost and increases revenue as well as limits the environmental impact of over applying chemicals to a field.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,047, filed Nov. 20, 2025, entitled “Agricultural Harvesting Systems and Related Devices and Methods,” U.S. patent application Ser. No. 19/396,099, filed Nov. 20, 2025, entitled “Sprayer Nozzle Devices and Related Systems and Methods,” U.S. patent application Ser. No. 19/397,422, filed Nov. 21, 2025, entitled “Systems, Methods, and Devices for Increasing Machine Operating Range,” U.S. patent application Ser. No. 19/408,177, filed Dec. 3, 2025, entitled “Agricultural Guidance and Navigation System and Related Devices and Methods,” U.S. patent application Ser. No. 19/467,539, filed Feb. 2, 2026, entitled “System and Automatic Adjustment to Target Pressure and Related Devices and Methods,” U.S. patent application Ser. No. 19/467,588, filed Feb. 2, 2026, entitled “Harvester Liquid Application System, Devices, and Methods,” U.S. patent application Ser. No. 19/468,722, filed Feb. 3, 2026, entitled “Agricultural Navigation Methods, Devices, and Systems,” U.S. patent application Ser. No. 19/468,873, filed Feb. 3, 2026, entitled “Agricultural Mapping and Related Devices, Systems, and Methods,” U.S. patent application Ser. No. 19/534,324, filed Feb. 9, 2026, entitled “Remote Assistance for Agricultural Display Methods and Related Devices and Systems,” U.S. patent application Ser. No. 19/537,260, filed Feb. 12, 2026, entitled “Agricultural Seed Meter and Related Devices, Systems, and Methods,” U.S. patent application Ser. No. 19/538,694, filed Feb. 12, 2026, entitled “Grain Fill Sensor and Related Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63/906,646, filed Oct. 28, 2025, entitled “Automated Grail Filling System and Related Devices and Methods,” U.S. Patent Application 63/967,084, filed Jan. 23, 2025, entitled “System and Methods of Row-by-Row Yield Monitoring,” U.S. Patent Application 63/966,976, filed Jan. 23, 2025, entitled “Dispatch Indicator Calibration,” and U.S. Patent Application 63/967,038, filed Jan. 23, 2025, entitled “Grain Fill Sensor and Related Devices, Systems, and Methods,” each of which is incorporated herein by reference.

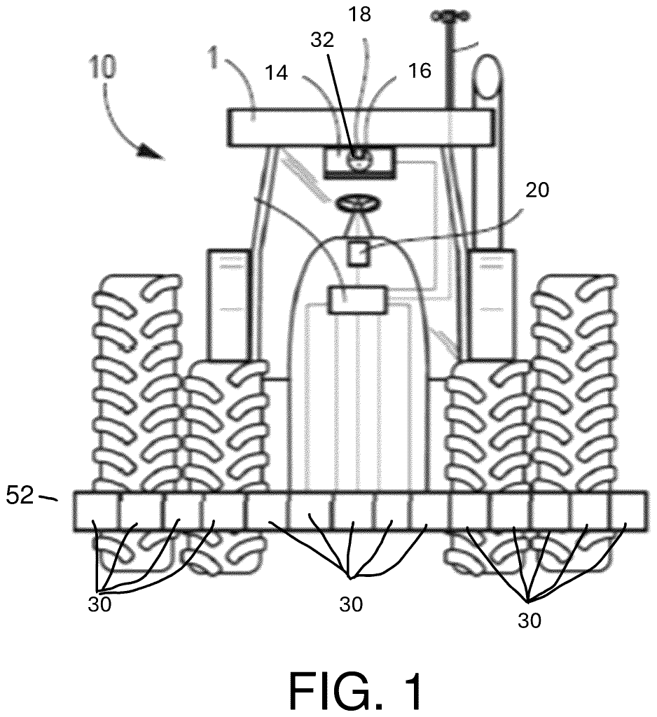

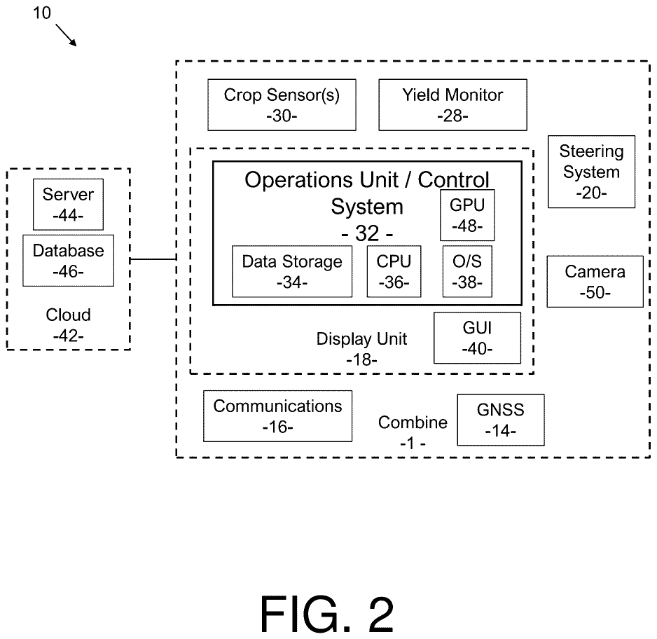

Turning to the figures in more detail, in various implementations the yield monitoring system 10 is implemented on a combine 1 or other harvesting agricultural vehicle, as would be understood, shown in FIG. 1. In various implementations, the system 10 includes a GNSS or GPS receiver 14 in operational communication with a vehicle system display 18, such as the InCommand® display from Ag Leader®, and an operations unit 32, as is shown in greater detail in FIG. 2. The system 10 optionally comprises various additional sensors, monitors and the like, as would be appreciated by those of skill in the art and as disclosed in various of the incorporated references.

The system 10, optionally, further includes an automatic and/or assisted steering system 20. As would be understood, various automatic and/or assisted steering systems 20 are configured to take inputs from an operations unit 32 navigate a vehicle through a field. Various steering systems 20 may manually and/or electronically manipulate the systems on board a harvest vehicle 1 to effectuate automatic and/or assisted steering, as would be appreciated by those of skill in the art. In various implementations, the automatic/assisted steering system 20 allows for autonomous navigation.

Continuing with FIGS. 1 and 2, in various implementations, the system 10 includes an operations unit 32, optionally integrated within the display 18, in operational communication with data link 16 (also referred to herein as a communications component 16). It is generally understood that these components may optionally be housed within the display unit 18 and that the representation of FIG. 2 is merely exemplary.

In certain implementations, the operations unit 32 is also configured for the sending and receiving of data for storage and processing, such as to the cloud 42, a remote server 44, database 46, and/or other cloud computing components readily understood in the art. Such connections by the operations unit 32, can be made wirelessly via understood internet and/or cellular technologies such as Bluetooth, Wi-Fi, LTE, 3G, 4G, or 5G connections, and the like. It is understood that in certain implementations, the operations unit 32 and/or cloud 42 component may comprise encryption or other data privacy components such as hardware, software, and/or firmware security aspects.

Continuing with FIG. 2, the operations unit 32, according to certain implementations, further has one or more optional processing and computing components, such as data storage 34, a CPU or processor 36, an operating system (“O/S”) 38, and other computing components necessary for implementing the various technologies disclosed herein. It is appreciated that the various optional system components are in operational communication with one another via wired or wireless connections and are configured to perform the processes and execute the commands described herein. As would be understood, each of these components can be located optionally at various locations around the vehicle 1 or elsewhere, such as in the cloud 42 and accessible by a wireless or cellular connection.

In various implementations, this connectivity means that an operator, enterprise manager, and/or other third party is able to receive notifications such as adjustment prompts and confirmation screens on their mobile devices or via another access point. In certain implementations, these individuals can review the various data collected or recorded by the system 10 and make adjustments, comments, and/or observations in real-time or near real-time, as would be readily appreciated.

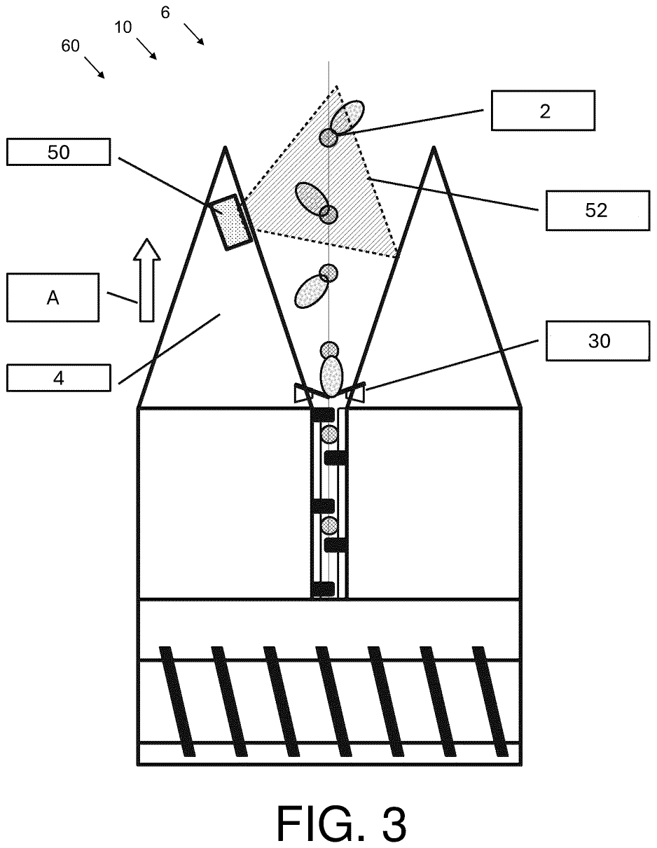

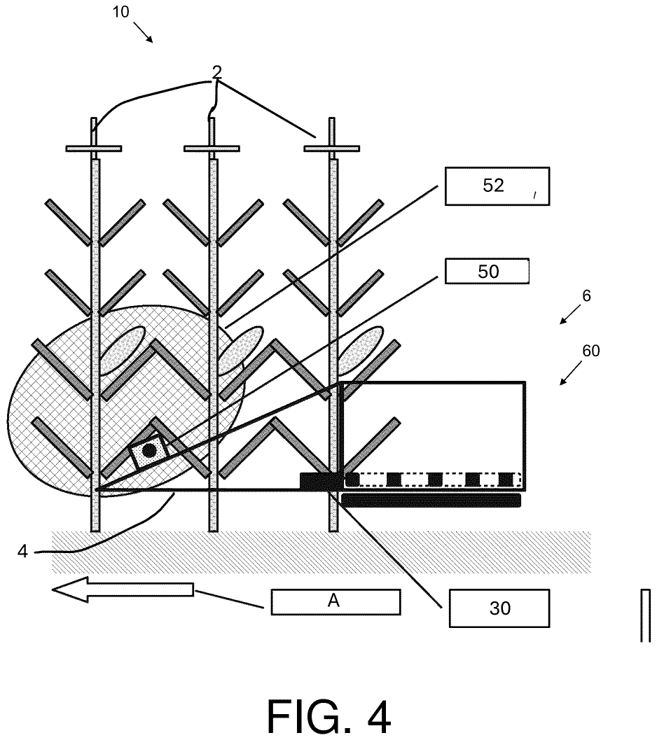

In one implementation of the row by row yield monitoring system 10, shown in FIGS. 3 and 4, a camera 50 is used along with a plant detection sensor 30 and mass flow yield monitor 28 (shown in FIG. 2) to estimate the amount of crop (e.g., corn) that is entering an individual row unit 60 of a harvester 1. In these and other implementations, the camera 50 is placed on the snoot 4 (i.e. the leading part of a crop row divider) of a harvester 1 head 6 and captures images of crops 2 entering the head 6 as it traverses the field, in the direction of arrow A. The camera 50 being positioned such that the camera's field of view 52 captures stalks and crop fruit (e.g., corn ears).

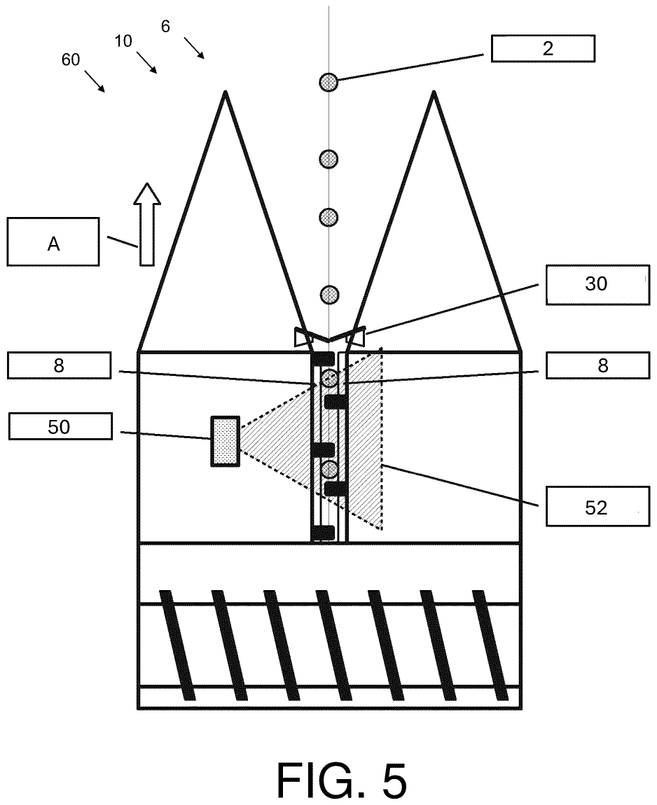

Other implementations like that shown for example in FIG. 5, including the camera 50 mounted in an alternative location, still capable of capturing image data of incoming crops and/or fruit (e.g., corn stalks and ears). In FIG. 5, the camera 50 is be positioned so its field-of-view covers the deck plate 8 area. The deck plate 8 area being the area of the harvesting row unit 60 where the stalk rolls positioned below the deck plates 8 pull the plants down through the deck plates 8. As would be understood, the deck plates 8 are spaced so that corn stalks and leaves can pass through, but corn ears cannot. As a corn plant 2 is pulled down, the attached ear strikes the deck plates 8, which snaps the ear's connection to the stalk, thus releasing the ear. This camera 50 placement captures images of the ears as the corn plants 2 are being pulled down.

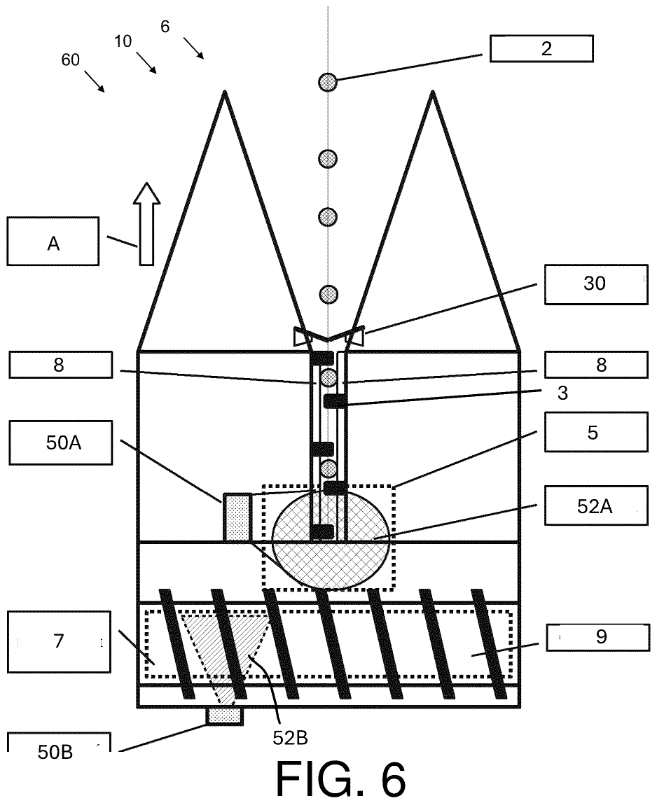

In a further alternate implementation, shown in FIG. 6, a camera 50A is positioned so its field-of-view 52A covers the ear intake area 5. As would be appreciated, the ear intake area 8 is the area of the harvesting row unit 60 at the rear of the deck plates 8 rearward to the cross auger 7. Once ears are disconnected from stalks, as described above, the loose ears are propelled by the gathering chains 3 and incoming corn plants into the ear intake area 5 and through to the cross auger 7.

In a still further alternative implementation, also shown in FIG. 6, the camera 50B (or cameras 50B) are positioned such that their field of view 52B is positioned on some portion of the cross-auger 7 ear transport area 9 (i.e. the curved area below the cross auger). The cross auger 7 is the device (i.e., a rotating cylinder with angled flighting) at the rear of the header 6 intake area. The rotation of the auger 7 and its angled flighting push corn ears that have settled into the ear transport area towards the combine's feeder where they are pulled into the combine's threshing apparatus, as would be understood. The cross-auger ear transport area 9 offers the opportunity to capture images of the ears being pushed along. The movement and positioning of the ears in this area is generally predictable. At this point in the harvesting process, the ears have been separated from the plants and most of the plant material has been pulled down beneath the header 6 by the stalk rolls.

In some implementations, the camera 50B may be positioned so that its field of view 52B view is a portion of the ear transport area 9 underneath the cross-auger 7. As ears travel along the ear transport area 9, the camera 50B is able to capture images of the ears.

A camera 50B with field of view 52B in the ear transport area 9 and its image processing are able to detect and size ears for all harvesting row units 60 outward (or upstream) of the camera's 50B position. Implementing row-by-row yield monitoring with this approach requires cameras 50B be positioned between each of the harvesting row units 60 so that the system 10 can produce a size (mass or volume) estimate of the ears at each point and then calculate the size estimate that each row has contributed to the overall ear stream based on the size estimate of the current position and the size estimate of the next upstream row.

In various implementations, the system 10 may include one, two, or more cameras 50 in various locations on each row unit 60 or between the row units 60.

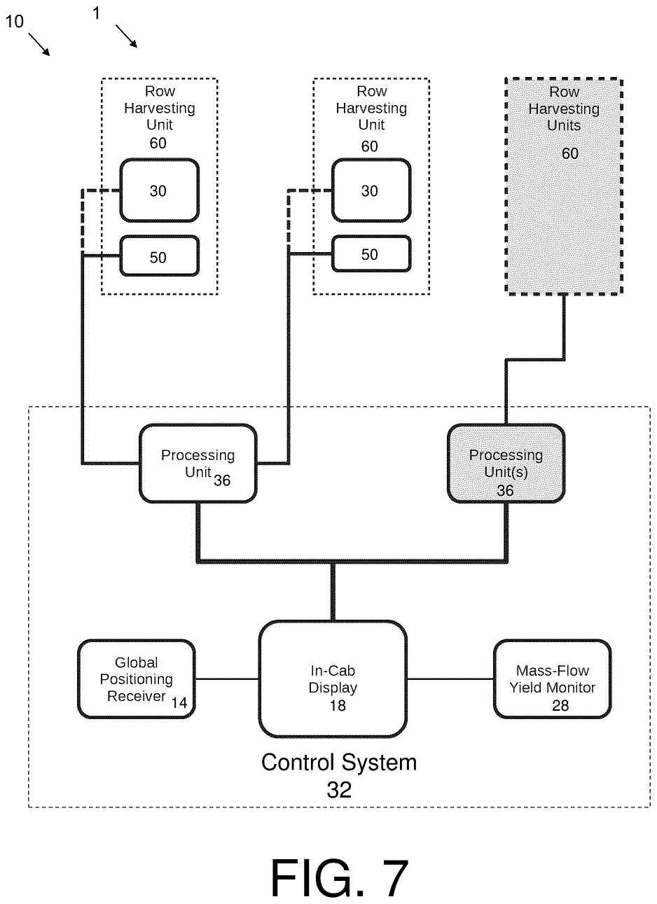

Turning now to FIGS. 2 and 7, in various implementations the captured image data is transferred to a processing unit 36. The processing unit 36 runs image processing software designed to detect and measure the size (width and length) of the ears being harvested. Measuring the size of the ears allows the system 10 to estimate the mass and/or volume of corn kernels on each corn ear and thus allows an estimation of the yield for the individual row. Yield data may be presented several different ways, including but not limited to: Mass Per Plant (e.g. lbs/plant) or Mass Per Number of Plants (e.g. lbs/1000 plants); Mass Per Area (e.g. lbs/acre); Volume Per Plant (e.g. bushels/plant) or Volume Per Number of Plants (e.g. bushels/1000 plants); and Volume Per Area (e.g. bushels/acre)

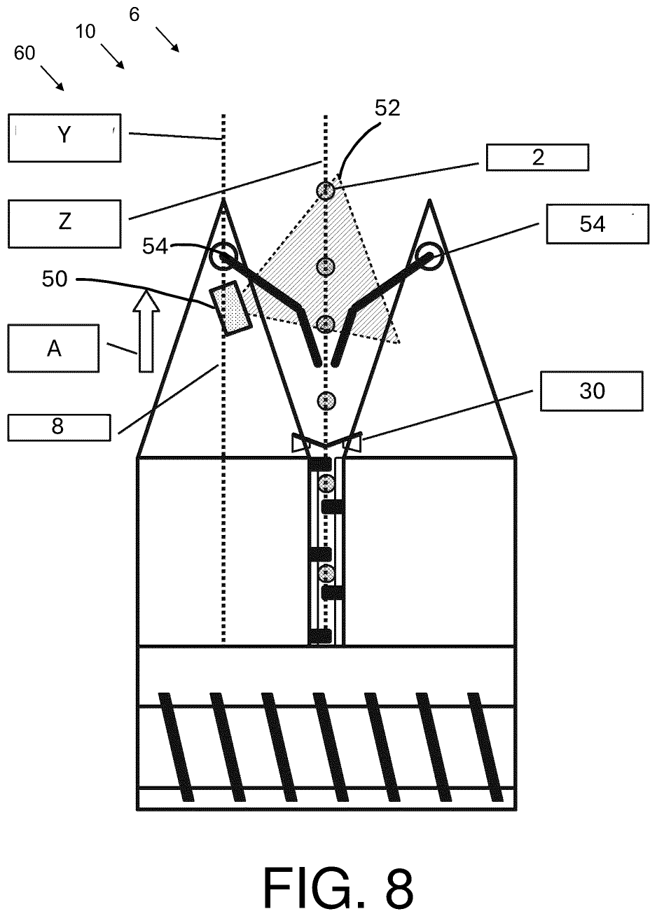

In order to measure the size of an ear on an incoming corn plant, the camera 50 and system 10 must determine the distance from camera-to-ear. This may be accomplished in several different ways. One implementation includes a depth sensor accompanying the camera 50. In a further implementations, the camera 50 is a stereo camera that allows depth measurement. A still further implementation includes the use of row alignment sensors 54 that allow measurement from camera to corn row, shown for example in FIG. 8. A further implementation includes utilizing high-accuracy (RTK) current GPS position and orientation of harvester along with previous collected data of position/alignment of planted corn rows. One, two or more of these methods and devices may be implemented.

FIG. 8 illustrates an example of how the camera-to-plant distance may be calculated. In these and other implementations, the row feeler sensor 54 is a spring-loaded arm that extends out to make contact with the corn plants, as would be generally understood. The system 10 is able measure the angle of rotation of the row feeler 54 (arm) that aligns it with the planted row. When the angle of rotation is known for the row feelers 54 on either side of the row, it is possible to calculate the alignment of the harvesting row (shown at axis Y) to the plant row (shown at axis Z). The alignment is the distance from the row feeler sensor 54 to the planted row axis Z and the relative angle of harvesting row axis Z to the planted row axis Y.

In various implementations, data from a stalk detection sensor 30 may be used in calculating alignment of harvesting row (axis Y) to plant row (axis Z) as the sensor 30 can determine the distance from the sensor 30 to the planted row Z. This, in turn, enables a distance calculation from a point on the crop divider/snoot 4 like the mounting point of the camera 50 to the plant row Z.

As has previously been described, one of the challenges with using a camera 50 on the corn head 6 is that corn plants 2 have long and wide leaves that can prevent the camera 50 from capturing an unobstructed image of the ear on the plant 2. In addition to leaves, other possible reasons for ear obscuration include stalks of other closely spaced corn plants and orientation of the ear on the corn plant relative to the camera 50.

To detect and accurately measure the ear, most of the ear has to be visible in the images produced by the camera 50. It is accepted that a proportion of the ears entering the harvester 1 may not be detectable or measurable due to obscuration by adjacent corn plant 2 leaves and stalks. Therefore, a camera 50 alone cannot detect and size every ear. In various implementations, a plant detection sensor 30 is included with the system 10 because it can detect each corn plant 2 as it enters the header 6. Corn plant detection sensors have been described previously, including in various of the incorporated references including U.S. patent application Ser. No. 17/013,037, U.S. patent application Ser. No. 17/226,002, U.S. Pat. No. 11,758,848, U.S. patent application Ser. No. 18/516,514.

The system 10 is configured to estimate the yield of each row unit 60 by using the mass flow sensor 28 data and counted plant data (from a sensor 30) along with the ear sizing data (from the camera 50 and subsequent processing). When ears are not detectable and/or measurable due to image obscuration, but a corn plant was detected, the system 10 may utilize an estimate for the size of the ear based on the ears that were able to be sized.

Consider an example for a combine harvester 1 with an 8-row header where each row is 30 inches. The total header width is 20 feet. The combine is harvesting corn at 4 miles per hour. If the sample time is 1 second, based on the combine speed, the sample region has a length of 5.87 feet and an area of 0.000337 acre/row). For a particular sample region, the mass flow sensor 28 measures a grain flow of 28 pounds (mass flow for all 8 harvested rows). In this example the system 10 counted plants and detected and measured ears according to the data in Table 1.

TABLE 1
Row Yield Calculation Example

| Row | 1 | 2 | 3 | 4 | 5 | 6 | 7 | 8 | Total |
|---|---|---|---|---|---|---|---|---|---|
| Counted Plants | 10 | 11 | 9 | 8 | 9 | 7 | 6 | 5 | 65 |
| Ears Detected | 4 | 4 | 6 | 5 | 7 | 3 | 4 | 3 | 36 |
| Ears Sized | 3 | 3 | 4 | 4 | 5 | 3 | 2 | 3 | 27 |
| Measured Ear Size | 7 | 6 | 7 | 8 | 7 | 6 | 6 | 6 | 53 |
| Plants × Ear Size | 70 | 66 | 63 | 64 | 63 | 42 | 36 | 30 | 434 |
| Proportion of Mass | 16.1% | 15.2% | 14.5% | 14.7% | 14.5% | 9.7% | 8.3% | 6.9% | 100.0% |
| Flow | | | | | | | | | |
| Mass Per Row (lbs) | 4.5 | 4.3 | 4.1 | 4.1 | 4.1 | 2.7 | 2.3 | 1.9 | 28 |
| Yield by Row (lbs/acre) | 13413 | 12647 | 12072 | 12263 | 12072 | 8048 | 6898 | 5748 | 10395 |
| Yield by Row (bu/acre) | 240 | 226 | 216 | 219 | 216 | 144 | 123 | 103 | 186 |

For measured ear size, a formula may be implemented where the width and length of an ear corresponds to an ear size value on a scale from 1 to 10 such that ear size=1 is a very small ear and ear size=10 is a very large ear. This scaling is a way to approximate the kernel mass of the ear although it should be appreciated that other methods for estimating kernel mass based on measured ear size could also be used.

In various implementations the system 10 multiplies the counted plants by the measured ear size for each row to determine a “Plant-Ear” value. The sum of the Plant-Ear values for all rows is used to find the Plant-Ear Total. The mass flow proportion for each row is calculated by dividing the row's Plant-Ear value by the Plant-Ear Total. Table 1 shows the percentage of mass flow calculated for each row, in the example, based on the Plant-Ear value. The estimated mass flow for each row may be used to calculate the yield for each row. In the example presented, yields ranging from 13413 pounds/acre down to 5748 pounds/acre can be seen. Without the adjustment for counted plants and measured ears, all rows were assigned the estimate based on the overall header width (10395 pounds/acre).

The example used a single measurement for combine 1 speed, as would happen if the combine were moving in a straight line across the ground. In some instances, the combine 1 may be moving along a curved path such that the speed of each row of the header may be moving at a different speed. Thus, the system 10 may calculate speed and sample region length for each individual row and base the subsequent row yield calculations on that, rather than using a single speed for calculating the size of the sample region for all rows.

Crop harvested by the rows at the edges of the header has a longer distance to travel along the cross-auger 7 before reaching the feeder housing. This results in a different transport time from each header row to the mass flow sensor.

For each sensor mode in the system 10 (camera 50, plant detection 30, mass-flow 28), the sample data for a particular point in the field occurs at a different time. For example, in certain implementations, the ear measurement camera 50 will detect the ears on plants shortly before those plants go through the plant detection sensor 30. At a normal harvesting speed, this is a short time difference compared to the difference between the plant detection sensor 30 and the mass flow sensor 28. The mass flow sensor 28 sample for a particular point in the field occurs after the ears at that point are stripped, fed from header 6 to feeder and into the threshing system. Then, the grain from those ears must fall down into the clean grain sump where it is then moved and lifted by the clean grain elevator system to the top of the elevator where it strikes the mass-flow sensor 28. On typical corn harvesters 1, this process can take anywhere from 7 to 14 seconds. This requires that the system 10 align the data in time by holding each sensor 50, 30, 28 mode's data in a time delay buffer and aligning the data buffers so that each sensor 50, 30, 28 mode's sample corresponds to the same point (or sample region) in the field.

The time delay in this data may vary with operating conditions, as mentioned above, and the harvesting mechanisms' condition. Further accuracy may be achieved by estimating time delays using a state estimation algorithm to minimize an error cost function. One example is a Kalman filter. This algorithm may only use the measurement from the harvest sensors 50, 30, 28, or include vehicle operational measurements such as ground speed, turning rate, cross-auger speed, and gathering chain speed.

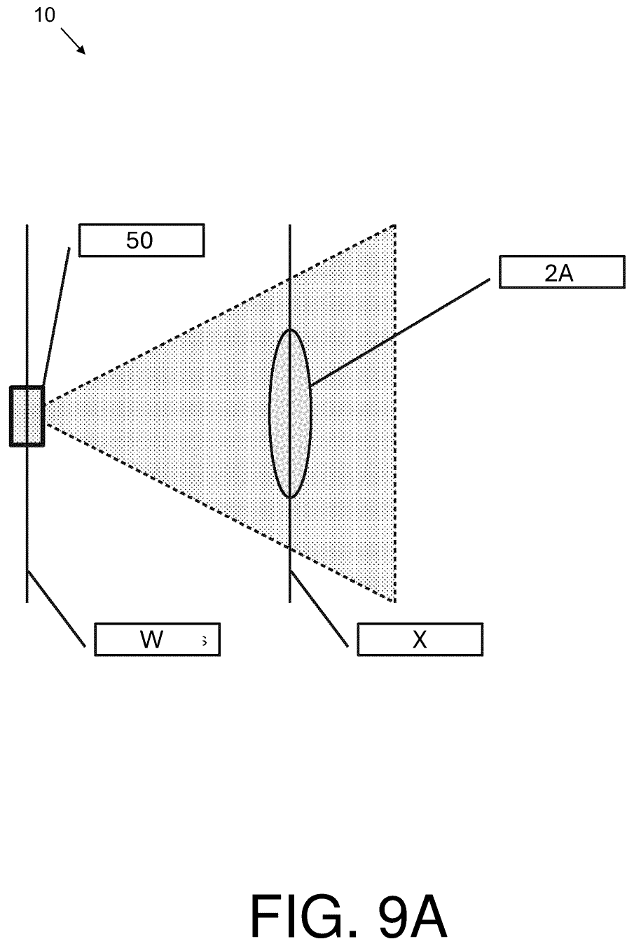

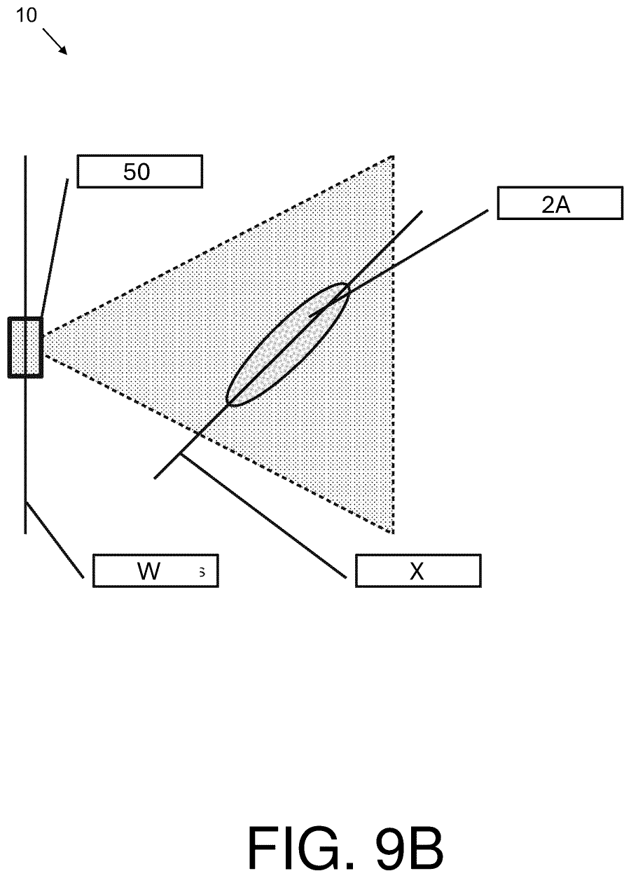

When the system 10 detects a corn ear 2A, it measures the width and length of the ear 2A based on the measured (or estimated) distance to the ear 2A from the camera 50 and the estimated pose (alignment of the ear axes X to the camera axes W) of the ear 2A. FIGS. 9A and 9B show illustrations of ear pose relative to the camera 50 and the alignment of the ear axis X to the camera axis W in one dimension. Full ear pose relative to the camera 50 is based on each of the three-dimensional axes of the camera (for a Cartesian coordinate system). With a depth sensing camera 50, the distance (in the dimension) to the points corresponding to image locations on the detected ear 2A allow the ear axis X to be estimated (for the dimension). Spherical coordinates may also be used for calculating ear 2A pose based on the camera 50 depth data so that ear 2A length and width can be estimated.

On mature corn (corn that can be harvested), the corn ears 2A may or may not be covered by the husk. As would be understood, the husk is the leaf-like material that surrounds the ear as it grows. Depending on corn variety and conditions, as the corn matures toward harvest, the husk may dry up and fall away from the ear. Thus, it can be expected that some proportion of the harvested ears are covered by the husk and some proportion are not. For an ear where the husk has fallen away and the ear is exposed, measurement of the dimensions of the ear may be more precise. If the detected ear is still encased in the husk, there may be some estimation made of the actual ear size based on the measurement of the ear still covered by the husk.

The techniques, processes, and steps described herein may be implemented, in whole or in part, as computer-implemented processes executed by one or more computing systems. In certain implementations, the disclosed methods are carried out by program code stored on a non-transitory computer-readable medium and executed by one or more processors. In other implementations, dedicated hardware such as application-specific integrated circuits (ASICs), field-programmable gate arrays (FPGAs), digital signal processors (DSPs), or system-on-chip (SoC) devices may implement all or portions of the functionality described herein. Hybrid implementations combining software and hardware are also contemplated.

In various implementations, a computing system includes one or more processors coupled to memory, persistent storage, and input/output (I/O) interfaces over one or more buses. The processors may include central processing units (CPUs), graphics processing units (GPUs), tensor processing units (TPUs), neural processing units (NPUs), or other general- or special-purpose processing devices. The memory may include volatile memory (e.g., RAM) and non-volatile memory (e.g., flash, ROM). The storage may include magnetic, optical, or solid-state devices. The I/O interfaces may include network interfaces, display controllers, keyboard and pointing device controllers, touchscreen interfaces, cameras, microphones, sensors, and other peripherals. A network interface may provide connectivity over wired or wireless links, including Ethernet, Wi Fi, Bluetooth, cellular (e.g., 4G/5G), satellite, or other protocols.

In some implementations, the computing system operates in a client-server or multi-tier architecture. For example, a client device (e.g., a smartphone, tablet, laptop, desktop computer, or embedded system) executes a client application that communicates with one or more servers over a network. The servers may include application servers, database servers, or microservices deployed in an on-premises environment, a private cloud, a public cloud, or a hybrid cloud. Load balancers, API gateways, message queues, and container orchestration platforms (e.g., Kubernetes) may support scalability and resilience. Data may be stored in relational databases, NoSQL stores, object stores, in-memory caches, or distributed file systems, with appropriate indexing, partitioning, replication, and consistency controls.

The functionality described herein may be organized into modules, components, services, or engines implemented in software, firmware, hardware, or combinations thereof. A “module” or “component” refers to executable instructions, logic, circuitry, or combinations thereof that perform the described operations. Modules may run on a single device or be distributed across multiple devices or services. Inter-module communication may be implemented via function calls, remote procedure calls (RPCs), message queues, publish/subscribe mechanisms, RESTful or gRPC interfaces, or other suitable techniques.

Any process, workflow, or algorithm described herein may be implemented as computer-executable instructions that, when executed by one or more processors, cause the processors to perform the steps of the process. Unless expressly stated otherwise, the order of steps is not limiting, and steps may be performed in parallel, omitted, repeated, combined, subdivided, or reordered to achieve substantively equivalent results. Loops, branches, and conditional operations may be implemented using control flow constructs. Data transformations may be expressed as functional pipelines, directed acyclic graphs (DAGs), or state machines.

By way of non-limiting example, in a representative implementation, the processor(s) execute instructions to: (1) receive or acquire input data from one or more sources via the I/O interfaces or network interface; (2) pre-process the input data (e.g., validation, normalization, filtering, parsing, tokenization, encoding, compression, or encryption/decryption as applicable); (3) process the data according to the techniques described herein, which may include one or more of: rule-based evaluation, statistical analysis, optimization, simulation, search, inference, pattern recognition, or machine learning-based operations; (4) generate output data, results, or control signals; and (5) store the results to memory or storage and/or transmit the results to another device or service through the network interface, and optionally display or render the results via a user interface.

In certain embodiments, the subject matter is implemented as program code stored on one or more non-transitory computer-readable media. Suitable media include, without limitation, magnetic disks, optical disks, solid-state drives, flash memory devices, ROM, RAM, and other tangible storage media. The program code may be written in any suitable programming language, including low-level languages (e.g., C/C++), high-level languages (e.g., Java, C#, Go, Rust, Python, JavaScript/TypeScript), hardware description languages for hardware embodiments (e.g., Verilog, VHDL), or combinations thereof. The program code may be interpreted, compiled, or just-in-time compiled, and may run in virtual machines, containers, sandboxes, trusted execution environments, or bare-metal environments.

The disclosed techniques may be deployed in centralized, distributed, and/or edge computing environments. In distributed embodiments, computational tasks may be partitioned across nodes and coordinated using consensus protocols, distributed scheduling, or orchestration frameworks. Data consistency may employ eventual or strong consistency models as appropriate to the use case. Edge devices may pre-process data to reduce latency or bandwidth usage and may operate intermittently with synchronization occurring when connectivity is available. The system may employ caching layers, content delivery networks (CDNs), or peer-to-peer mechanisms to enhance performance and reliability.

Implementations may incorporate security features such as authentication, authorization, access control, encryption at rest and in transit, secure key management, secure boot, code signing, attestation, intrusion detection, anomaly detection, rate limiting, and audit logging. Data handling may comply with applicable legal or regulatory frameworks and industry standards. Privacy-preserving techniques (e.g., data minimization, anonymization/pseudonymization, differential privacy, secure multi-party computation, homomorphic encryption) may be employed where appropriate. Logging and telemetry may be configurable to capture operational metrics, performance data, and errors while adhering to privacy and security requirements.

Where applicable, implementations may include graphical user interfaces (GUIs), command-line interfaces (CLIs), web interfaces, mobile applications, application programming interfaces (APIs), or combinations thereof. GUIs may be implemented with standard UI frameworks and may present forms, dashboards, visualizations, notifications, and controls enabling users to invoke or configure the methods described herein. Accessibility considerations (e.g., screen reader compatibility, keyboard navigation, color contrast) may be incorporated.

The system may operate on data represented as structured records, relational tables, graphs, trees, key-value maps, JSON/XML/YAML documents, binary blobs, images, audio, video, or domain-specific formats. Serialization may use JSON, Protocol Buffers, Avro, Thrift, MessagePack, or other formats. Where appropriate, schemas may be versioned and validated to maintain backward and forward compatibility.

An example computing environment includes a user device comprising: at least one processor; memory storing instructions; a display; one or more input devices; and a network interface. The instructions, when executed by the processor, cause the device to perform any of the methods disclosed herein. In a networked implementation, the user device communicatively couples to an application server via a network. The application server comprises at least one processor, memory, persistent storage, and a network interface, and executes service logic implementing operations as described. A database server coupled to the application server stores data structures used and/or generated by the operations, and may support transactions, indexing, query processing, and backup/restore. The components may be geographically co-located or distributed.

Although the disclosure has been described with references to various embodiments, persons skilled in the art will recognize that changes may be made in form and detail without departing from the spirit and scope of this disclosure.

What is claimed is:

1. A row-by-row yield monitoring system for a harvester having a plurality of row units, the system comprising:
(a) a camera configured to capture images of crop entering at least one row unit of the harvester;
(b) a plant detection sensor configured to detect individual crop plants entering the at least one row unit;
(c) a mass flow yield sensor configured to measure a total mass flow of harvested crop; and
(d) a processor in communication with the camera, the plant detection sensor, and the mass flow yield sensor, the processor configured to:
(i) receive image data from the camera;
(ii) detect and measure a size of crop fruit in the image data;
(iii) receive plant count data from the plant detection sensor;
(iv) receive mass flow data from the mass flow yield sensor; and
(v) estimate a yield for each individual row unit based on the crop fruit size, the plant count data, and the mass flow data.

2. The system of claim 1, wherein the camera is mounted on a snoot of the harvester and positioned such that a field of view of the camera captures crop stalks and crop fruit entering the at least one row unit.

3. The system of claim 1, wherein the camera is positioned such that a field of view of the camera covers a deck plate area of the at least one row unit.

4. The system of claim 1, wherein the camera is positioned such that a field of view of the camera covers an ear intake area of the at least one row unit.

5. The system of claim 1, wherein the camera is positioned such that a field of view of the camera covers a cross-auger ear transport area of the harvester.

6. The system of claim 1, further comprising a depth sensor configured to determine a distance from the camera to crop fruit.

7. The system of claim 1, wherein the camera is a stereo camera configured to measure depth.

8. The system of claim 1, further comprising a row alignment sensor configured to measure a distance from the camera to a planted crop row.

9. The system of claim 1, wherein the processor is further configured to:
(a) multiply a counted plant number by a measured crop fruit size for each row unit to determine a plant-fruit value for each of the plurality of row units;
(b) sum the plant-fruit values for each of the plurality of row units to determine a plant-fruit total; and
(c) calculate a mass flow proportion for each of the plurality of row units by dividing the plant-fruit value of each of the plurality of row units by the plant-fruit total.

10. The system of claim 1, wherein the processor is further configured to align data from the camera, the plant detection sensor, and the mass flow yield sensor in time using a time delay buffer.

11. The system of claim 10, wherein the processor is further configured to estimate time delays using a state estimation algorithm.

12. The system of claim 1, wherein the processor is further configured to calculate a speed and sample region length for each individual row unit when the harvester is moving along a curved path.

13. A method of estimating row-by-row yield during harvesting, the method comprising:
capturing, via a camera, images of crop entering a plurality of row units of a harvester;
detecting and measuring, via a processor, a size of crop fruit in the captured images;
detecting, via a plant detection sensor, individual crop plants entering each row unit;
measuring, via a mass flow yield sensor, a total mass flow of harvested crop; and
estimating, via the processor, a yield for each individual row unit based on the crop fruit size, a plant count from the plant detection sensor, and the total mass flow.

14. The method of claim 13, further comprising:
multiplying a counted plant number by a measured crop fruit size for each row unit to determine a plant-fruit value;
summing the plant-fruit values for each of the plurality of row units to determine a plant-fruit total;
calculating a mass flow proportion for each of the plurality of row units by dividing the plant-fruit value of each of the plurality of row units by the plant-fruit total; and
calculating the yield for each of the plurality of row units based on the mass flow proportion.

15. The method of claim 13, further comprising determining a distance from the camera to the crop fruit using at least one of: a depth sensor, a stereo camera, a row alignment sensor, or GPS position data combined with previously collected planted row position data.

16. The method of claim 13, further comprising aligning data from the camera, the plant detection sensor, and the mass flow yield sensor in time by holding data from each sensor in a time delay buffer.

17. The method of claim 16, further comprising estimating time delays using a state estimation algorithm.

18. The method of claim 13, further comprising estimating, for crop plants where crop fruit is not detectable in the captured images due to obscuration, a size of the crop fruit based on sizes of crop fruit that were detected and measured.

19. A non-transitory computer-readable medium storing instructions that, when executed by a processor, cause the processor to:
(a) receive image data from a camera capturing images of crop entering a plurality of row units of a harvester;
(b) detect and measure a size of crop fruit in the image data;
(c) receive plant count data from a plant detection sensor detecting individual crop plants entering each row unit;
(d) receive mass flow data from a mass flow yield sensor measuring a total mass flow of harvested crop; and
(e) estimate a yield for each individual row unit based on the crop fruit size, the plant count data, and the mass flow data.

20. The non-transitory computer-readable medium of claim 19, the processor further configured to align data from the camera, the plant detection sensor, and the mass flow yield sensor in time by holding data from each sensor in a time delay buffer.
